(19) United States
(12) Patent Application Publication
(10) Pub. No.: US 2009/0154162 A1
(43) Pub. Date: Jun. 18, 2009

(54) ILLUMINATING POST CAP

(75) Inventor: Duane M. McCall, Englewood, CO (US)

Correspondence Address: McCarthy Law Group, 5830 Northwest Expressway, # 353, OKLAHOMA CITY, OK, 73132, US

(73) Assignee: MILE HIGH BALUSTERS, Englewood, CO (US)

(21) Appl. No.: 12/210,801

(22) Filed: Sep. 15, 2008

Related U.S. Application Data
(60) Provisional application No. 60/993,643, filed on Sep. 13, 2007.

(51) Int. Cl. F21S 4/00

(52) U.S. Cl. 362/249.16

(57) ABSTRACT

An illuminating post cap having a housing defining a support surface and further defining a shroud circumscribing an opening adjacent the support surface. A strip assembly has a substrate operably supported by the support surface, and a lighting member is electrically connected to the substrate and operably receivingly disposed within the shroud in a characteristic close mating relationship.

### RELATED APPLICATION

This application claims the benefit of the filing date of Sep. 13, 2007 for U.S. Provisional Application Ser. No. 60/993,643.

### FIELD

This invention is directed to ornamental lighting and more particularly without limitation to an illuminating post cap on a barrier.

### BRIEF DESCRIPTION OF THE DRAWINGS

FIG. 1 depicts an illuminating post cap at nighttime in accordance with the present embodiments.

FIG. 2 depicts a strip assembly having four LEDs suited for use in the post cap of FIG. 1.

FIG. 3 depicts a strip assembly having six LEDs suited for use in the post cap of FIG. 1.

FIG. 4 depicts a strip assembly operably installed in a post cap having internal support features in accordance with embodiments of the present invention.

FIG. 5 is a cross sectional view of the strip assembly and post cap of FIG. 4 detailing the manner in which each LED is operably receivingly engaged and recessed in the shroud defined by the cap.

### DETAILED DESCRIPTION

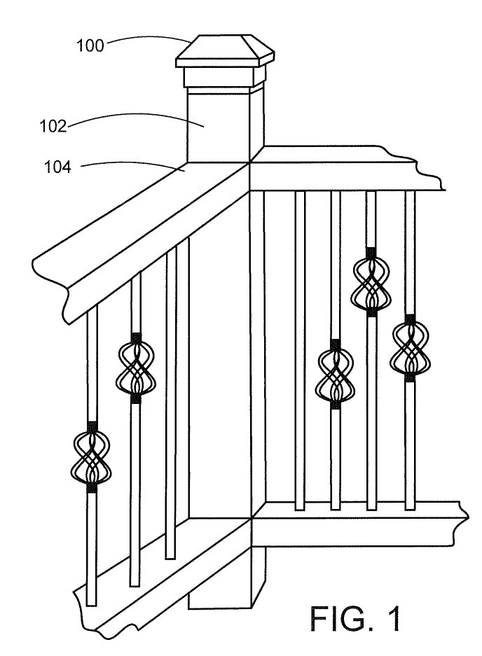

FIG. 1 is a nighttime depiction of an illuminating post cap 100 that is constructed in accordance with embodiments of the present invention. It will be noted that the post cap 100 directs light downwardly to illuminate the post 102 upon which it is supported as well as the railings 104 attached to the post 102. Shedding light onto the post 102 is a desirable nighttime feature that enhances the aesthetic value of the ornamental barrier of which the post cap 100 forms a part. As discussed below, each light inside the post cap 100 is recessed within a shroud that directs the emitted light downwardly in these depicted embodiments. Directing the light downwardly onto the post 102 prevents the undesirable glare that is otherwise associated with lighting that is directed horizontally, as in previously attempted solutions in the art.

The claimed embodiments are not limited to a particular number and size or intensity of the lights illuminating the cap 100. FIG. 1 depicts an illustrative illuminating post cap 100 according to the present embodiments, like that marketed by De-Kor™ as the Grande Cap, the Rondi Cap, and the Little Rondi Cap. The Grande Cap and the Rondi Cap have six light-emitting diodes (“LEDs”) per side, and the Little Rondi Cap has four LEDs per side.

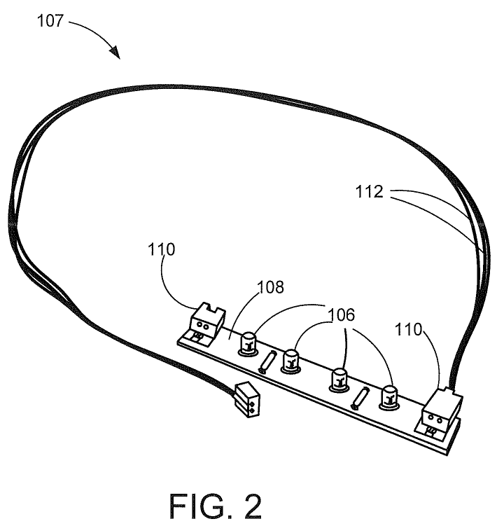

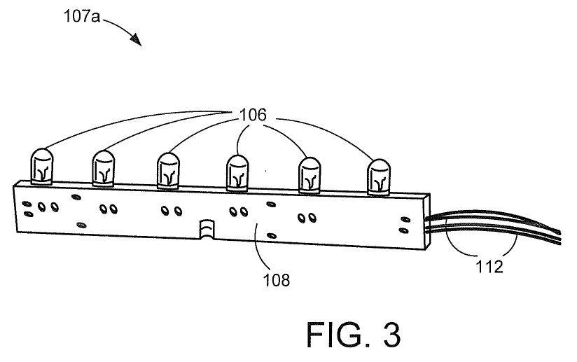

FIG. 2 depicts a strip assembly 107 made of four direct-current (“dc”) LEDs 106 mounted electrically in series with one-another on a rigid substrate 108. Preferably, the LEDs 106 are hermetically sealed to make them weatherproof for outdoor use or high humidity indoor use. Connectors 110 are mounted at each end of the substrate 108 and electrically connected to the LEDs 106. Electrical leads 112 are depicted connected to one of the connectors 110. The leads 112 can be routed through the post 102 and railing 104 to supply power to the LEDs 106. Another strip assembly (not shown) can be electrically connected to the strip assembly 107 via another lead connected to the other connector 110. FIG. 3 similarly shows another strip assembly 107a made of six LEDs 106 connected to the substrate 108.

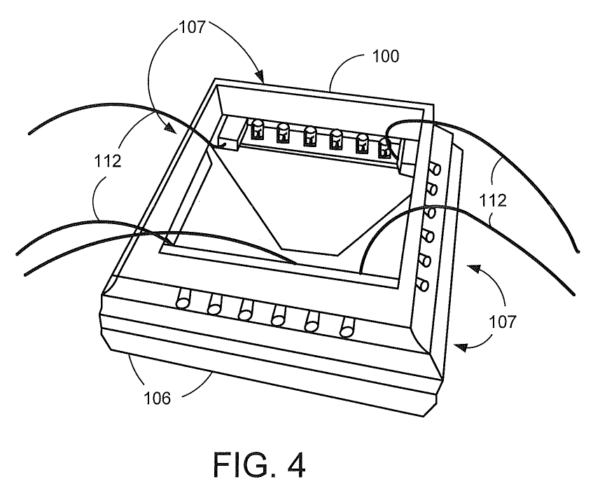

FIG. 4 is a bottom view of the cap 100, depicting how the strip assemblies 107 are receivingly engaged and thereby supported by features provided in the cap 100. Preferably, the cap 100 is constructed of a casting or a molding to provide the support features.

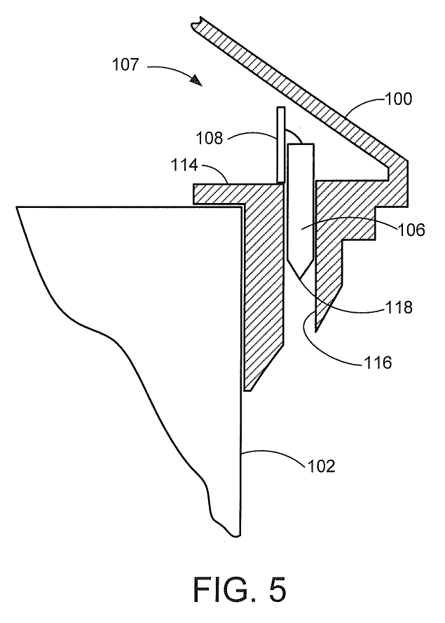

FIG. 5 is a cross sectional view of a portion of the cap 100 operably attached to the post 102. In these illustrative embodiments the cap 100 defines a support surface 114 upon which an edge of the substrate 108 rests. The LEDs 106 are spaced apart so that each LED 106 aligns with a shroud surface 116 defining an opening into which the respective LED 106 is receivingly engaged in a close mating relationship. The support surface 114 and shroud 116 cooperate to operably support the strip assembly 107 in place without the need of any additional fastener. In the depicted embodiments there is an individual shroud 116 for each of the LEDs 106. Alternatively, two or more LEDs 106 can be receivingly disposed within a shared shroud.

The shroud 116 completely surrounds the LED 106 and operably extends beyond a distal end 118 of the LED 106. This construction ensures that the light emitted by the LED 106 is directionally disposed in accordance with the orientation of the shroud 116. For example, in the depicted embodiments the shroud 116 directs all the light emitted by the LED 106 downwardly onto the post 102 and the railings 104 (FIG. 1) below. That advantageously provides a desired aesthetic lighting effect and improves nighttime visibility by preventing glare by the LEDs.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms. For example, the particular elements may vary in type or arrangement without departing from the spirit and scope of the present invention.

In addition, although that described herein is directed to an illuminating post cap for decorative purposes, it will be appreciated by those skilled in the art that the disclosed embodiments are not so limited and various other systems can utilize that which is disclosed herein without departing from the spirit and scope of the embodiments of the present invention.

What is claimed:

1. An illuminating post cap comprising:
a housing defining a support surface and defining a shroud circumscribing an opening adjacent the support surface; and
a strip assembly comprising:
a substrate operably supported by the support surface, and
a lighting member electrically connected to the substrate and operably receivingly disposed within the shroud in a characteristic close mating relationship.
